(19) United States
(12) Patent Application Publication
(10) Pub. No.: US 2008/0140670 A1
(43) Pub. Date: Jun. 12, 2008

(54) Netvariables in a recursive browser system

(76) Inventor: Joseph Pally, Katy, TX (US)

Correspondence Address: Benjamin Aaron Adler;ADLER & ASSOCIATES, 8011 Candle Lane, Houston, TX, 77071, US

(21) Appl. No.: 11/636,161

(22) Filed: Dec. 8, 2006

(51) Int. Cl. G06F 17/30; G06F 17/00; G06F 3/00

(52) U.S. Cl. 707/10; 707/101; 715/733; 707/E17.111; 707/E17.001

(57) ABSTRACT

Provided herein is a recursive web browser system including a recursive web browser, a network connection, a processor, and a computer memory storing one or more netvariables and executable instructions to manipulate the netvariables or content therein. Also provided is a method for retrieving web content using netvariables in the recursive web browser system. Further provided is a computer program product, including a memory, on which is stored a plurality of netvariables and the methods for retrieving and using web content.

### COMPUTER PROGRAM LISTING APPENDIX

Computer program listings are submitted on compact disc in compliance with 37 C.F.R. §1.96 and are incorporated by reference herein. A total of two (2) compact discs (including duplicates) are submitted herein. The files on each compact disc are listed below:

| Files | Size (KB) | Date Created |
|---|---|---|
| RecursiveBrowserCode.txt | 40 | May 29, 2006 |
| zBox.txt | 48 | May 29, 2006 |
| Handwriting.txt | 76 | May 29, 2006 |
| Netvariables.txt | 12 | Nov. 03, 2006 |

### BACKGROUND OF THE INVENTION

1. Field of the Invention

The present invention relates generally to the fields of computer technology and web browser systems. More specifically, the present invention provides a system and method to integrate media and to manipulate content within a recursive browser environment.

2. Description of the Related Art

The Internet is arguably the most important innovation of the computer generation. To browse or surf the World Wide Web (the Web) is the fastest and most popular method of obtaining information today. However, current web browsers are primarily read only with little interactive capability. The Internet is to “go to and visit” and not part of the experience. A user's experience on the Internet is a temporal series of URLs visited. Furthermore, group collaboration on the Web requires user authentication and is generally site specific.

In addition most users are interested only in snippets of a web site they visit. However, a user must open a word processing, drawing or similar application or access another website to utilize or build on these snippets, if desired, or, for example, to create a document or image de novo. Browsers lack the ability to integrate different types of media according to user preferences. Selective access is missing. A live web is not close to being a reality.

Creating a new browser to address these problems is not an easy solution. It is estimated that a new browser release can cost from $10 million to $100 million. In addition the development and release processes are extremely time consuming. As such, one solution is to use the browser itself to expand browser functionalities.

Thus, there is a significant need in the art for improvements in the area of user-driven experiences. Specifically, the present invention is deficient in systems and methods to display, manipulate and/or create content in a recursive browser environment. The present invention fulfills this long-standing need and desire in the art.

### SUMMARY OF THE INVENTION

The present invention is directed to a recursive web browser system. The recursive browser system comprises a computer having a processor and a recursive web browser configured to recursively display in a browser window thereof one or more recursive webpages therein and a network connection to one or more other computers comprising a network. Also, the recursive web browser system comprises a computer memory coupled to the processor storing at least one netvariable associated with a complete Uniform Resource Locator (URL) address and includes storing instructions adapted to be executed by the processor to manipulate the netvariable(s) or content therein and a means for retrieving or storing the netvariables onto the computer or the other computer(s) over the network. The present invention is directed to related recursive web browser systems further including, independently, executable instructions stored in the computer memory to create one or more netvariables and means for launching one or more user-requested actions executable on the netvariable(s).

The present invention also is directed to a recursive web browser. The recursive web browser comprises a recursive browser window configured to recursively display one or more recursive webpages, means for accessing a computer memory coupled to a processor and storing at least one netvariable as described herein and instructions adapted to be executed by the processor to manipulate the netvariable(s) or content therein, and means for launching one or more user-requested actions executable on the netvariable(s). The present invention is directed to a related recursive web browser further comprising a network connection to one or more computers comprising a network and means for retrieving the netvariables from or storing the netvariables onto the one or more computers. The present invention is directed to another related recursive web browser in which the computer memory further stores executable instructions to create one or more netvariables.

The present invention is directed further to a method for retrieving webpage content. The method comprises providing the recursive web browser system described herein and selecting one or more netvariables each corresponding to a complete Uniform Resource Locator (URL) address from a computer memory storing the same. The selected netvariable(s) are mapped to the corresponding complete URLs and the webpage content associated with the URL(s) is retrieved and displayed in a recursive browser page or window. The present invention is directed to a related method further comprising the independent steps of creating one or more netvariables and, optionally, of storing the same.

The present invention is directed to another related method further comprising implementing the netvariable as a collaborative page or window shared by two or more computers over the network and, optionally, changing content within the collaborative page or window thereby creating another netvariable containing the same therewithin and synchronizing the change to the content with other computers having access thereto. The present invention is directed to yet another related method further comprising applying an action parameter to the netvariable.

The present invention is directed further still to computer program product having a memory and a plurality of netvariables being stored in the memory. The computer program product memory further storing a method of retrieving webpage content. The method comprises mapping a selected netvariable to a corresponding complete URL and retrieving web page content associated with the URL(s) and displaying the retrieved content in a recursive browser page or window. The present invention is directed to related computer program products storing methods further comprising, independently, the steps described herein.

Other and further aspects, features and advantages of the present invention will be apparent from the following description of the presently preferred embodiments of the invention. These embodiments are given for the purpose of disclosure.

### BRIEF DESCRIPTION OF THE DRAWINGS

So that the matter in which the above-recited features, advantages and objects of the invention, as well as others which will become clear, are attained and can be understood in detail, more particular descriptions of the invention briefly summarized above may be had by reference to certain embodiments thereof which are illustrated in the appended drawings. These drawings form a part of the specification. It is to be noted, however, that the appended drawings illustrate preferred embodiments of the invention and therefore are not to be considered limiting in their scope.

FIGS. 1A-1B are flowcharts of the steps to add content to the Net Clipboard (FIG. 1A) and to retrieve content from the Net Clipboard (FIG. 1B) utilizing netvariables in a recursive browser environment.

FIG. 2 is a flowchart of the steps to Chat utilizing netvariables in a recursive browser environment.

FIG. 3 is a flowchart of the steps to participate in a NetDiscussion Room utilizing netvariables in a recursive browser environment.

### DETAILED DESCRIPTION OF THE INVENTION

In one embodiment of the present invention there is provided a recursive web browser system, comprising a computer having a processor and a recursive web browser configured to recursively display in a browser window thereof one or more recursive webpages therein; a network connection to one or more other computers comprising a network; a computer memory coupled to the processor storing at least one netvariable associated with a complete Uniform Resource Locator (URL) address, including storing instructions adapted to be executed by the processor to manipulate the netvariable(s) or content therein; and means for retrieving or storing the netvariables onto the computer or the other computer(s) over the network.

Further to this embodiment the recursive web browser further comprises means for launching one or more user-requested actions executable on the netvariable(s). A particular example of the means for launching a user-requested action is an action bar within a recursive browser window or an address bar located in a browser platform associated with the recursive web browser which triggers the action bar. Exemplary actions are effective to create a net variable, to get a netvariable, to set a netvariable, to cache a netvariable, or to change a value of a netvariable. Particularly, a change of a value may comprise a value increment, a value decrement or an automatic update of a value from another source.

In all aspects of these embodiments the computer memory of the recursive web browser further may include executable instructions to create one or more netvariables. Also the netvariable may comprise an assigned name and value pair. Optionally, the netvariable further may comprise a user passcode. In addition the netvariables or one or more changes thereto may be stored in a memory cache or on a hard disk. Furthermore, the netvariable may contain content comprising text, URL links, images, or a combination thereof or one or more ZCubes comprising the same.

In a particular aspect the netvariable may be implemented as a collaborative page or window shared by two or more computers over the network. Optionally, the collaborative page may be assigned a unique identifier to restrict user(s) access thereto. Also, a drag/drop action or creation of content within the page or window may create another netvariable therewithin containing the dropped or created content. Further to these actions a change to the content within a collaborative page or window may be synchronized with other computers having access thereto.

Examples of collaboration within the page may be chatting, messaging, a group discussion or other sharing of content contained within the collaborative web page. In these examples the content is stored only in cache memory. An example of collaboration within a window is a clipboard.

In another embodiment of the present invention there is provided a recursive web browser, comprising a recursive browser window configured to recursively display one or more recursive webpages; means for accessing a computer memory coupled to a processor and storing at least one netvariable described supra and instructions adapted to be executed by the processor to manipulate the netvariable(s) or content therein; and means for launching one or more user-requested actions executable on the netvariable(s).

Further to this embodiment, the recursive web browser may comprise a network connection to one or more computers comprising a network and means for retrieving the netvariables from or storing the netvariables onto the one or more computers. Also, in both embodiments the computer memory further may store executable instructions to create one or more netvariables. In addition the means for launching one or more user-requested actions is an action bar within a recursive browser window or an address bar located in a browser platform associated with the recursive web browser which triggers the action bar. The actions are as described supra.

In yet another embodiment of the present invention there is provided a method for retrieving webpage content, comprising providing the recursive web browser system described supra; selecting one or more netvariables each corresponding to a complete Uniform Resource Locator (URL) address from a computer memory storing the same; mapping the selected netvariable(s) to the corresponding complete URLs; and retrieving webpage content associated with the URL(s) and displaying the retrieved content in a recursive browser page or window.

Further to this embodiment the method may comprise creating one or more netvariables. Further still, the method optionally may comprise storing the created netvariable(s) in the computer memory. In one example the computer memory may comprise one or more computers networked within the recursive browser system.

In another further embodiment the method may comprise implementing the netvariable as a collaborative page or window shared by two or more computers over the network. The method, optionally, further may comprise assigning a unique identifier to the collaborative page to restrict user(s) access thereto. Further still, the method may comprise changing content within the collaborative page or window thereby creating another netvariable containing the same therewithin. The method, optionally, further may comprise synchronizing the change to the content with other computers having access thereto.

In yet another further embodiment the method may comprise applying an action parameter to the netvariable. Exemplary action parameters are effective to create a net variable, to get a netvariable, to set a netvariable, to cache a netvariable, or to change a value of a netvariable. As described supra, a change in value may comprise incrementing a value, decrementing a value, or updating automatically a value from another source.

In yet another embodiment of the present invention there is provided a computer program product having a memory, a plurality of netvariables being stored in the memory, the memory further storing a method of retrieving webpage content comprising the steps of mapping a selected netvariable to a corresponding complete URL; and retrieving web page content associated with the URL(s) and displaying the retrieved content in a recursive browser page or window.

In further embodiments the stored method may comprise further method steps as described supra. Also, the netvariables and action parameters applied thereto are as described supra. Furthermore, the implementation of netvariables as collabortive pages or windows and the specific implementations thereof are as described supra.

As used herein, the term “a” or “an” may mean one or more. As used herein in the claim(s), when used in conjunction with the word “comprising”, the words “a” or “an” may mean one or more than one. As used herein “another” or “other” may mean at least a second or more of the same or different claim element of components thereof.

As used herein, the term(s) “recursive browser” or “zBrowser” refers to a browser that uses existing browsers to enhance their functionality and to provide 3 dimensional multipart full browser functionality to improve browser experience.

As used herein, the term “Action Bar” refers to a targeting bar, which may be the conventional URL bar, that can also be triggered from html or :href calls invoking, e.g., one or more web actions, web sites, web services, or action triggers.

As used herein, the term(s) “ZCube” refers to a collection of one or more ZBoxes contained within a ZPage or recursive webpage where a “ZBox” is a part of a ZPage that contains an html object(s), for example, but not limited to, images, scripts, shockwave, and a recursive browser. ZBoxes are copyable and individually and selectively formattable with drag-drop of style text. “ZPage” or “recursive webpage” is a container of one or more ZCubes/zBoxes that encompasses logic to display, edit, move, browse, rotate, hide, animate, and run scripts within the recursive browser. Unless specifically indicated otherwise the terms “ZBox” and “ZCube” are interchangeable. A ZCube may be made from templates that are stored in a gallery. The ZCube may be moved/rotated over a user-defined path and then may be animated. A ZCube can be made “read only”. A ZCube may have push pins added to it or comprise other pointers. A ZCube may be in multiple layers.

As used herein, the term(s) “ZCube world” refers to one or more sets of ZCube collections displayed under one context to the user. A ZCube world may contain ZPages.

As used herein, the term “ZPaint” refers to an extension of Zebra, an application which enables manipulation or modification of the contents of a ZCube, to color or paint graphical objects on a webpage.

As used herein, the term “netvariable” refers to a Java servlet that provides data persistency for user defined variables on a web server. NetVariable supports two action modes, SET and CACHE, as described herein.

Provided herein are systems, methods, and computer program products by which, in an Internet environment, variables, i.e., netvariables, are defined, stored in either memory or physical storage and recalled as required in the Internet environment, including a recursive browser environment. Netvariables, inter alia, may be created, the content within a netvariable may be created, added, deleted, otherwise changed, queried, or shared. Effectively, netvariables can function as the Internet's global memory and can be used to remember anything.

The recursive web browser system comprises at least a computer memory methods and applications, etc. stored therein which are effective to control, manipulate or modify content within a networkable recursive browser environment. The recursive web browser or ZBrowser comprises an Action Bar within the recursive browser window or page or recursive webpage as an entry point for any retrievable URL or executable action trigger within the recursive browser environment. The ZBrowser is enabled to recursively display one or more zPages within the browser window whether containing content or blank. Furthermore, using the Action Bar, a user may interact or create within a ZPage or recursive webpage or may open one or more ZCubes within ZPage(s) or recursive webpages and retrieve or create content therein. Thus, the Action Bar is effective to trigger an action applied to a netvariable, as discussed herein.

Particularly, within the recursive browser environment a web address or other web content associated with the address, etc. can be given a name and a value pair to create the netvariable. Upon request, a user may increment or decrement these values. In addition, optionally, a user may attach a passcode/password while creating the netvariable. A passcode may be required to retrieve the value from the server. Netvariables may be created, viewed, updated, added, or removed from a server.

Also any content, including html files, images, text, etc. may be stored inside netvariables and may be retrieved and utilized, including as shared content, as desired by one or more users. Netvariables may be cached in server memory for speed and are not persisted in hard media. An example of cached netvariables is the messages communicated among collaborators. Thus, it is contemplated that user-friendly netvariable names may replace the standard URLs, as they are used today.

To use netvariables, a user may build a form and set the action to /NetVariable. “post” can be used so that parameters are not limited to the URL length. Alternatively, the netvariables may be called with parameters directly. Only “ACTION” is a required parameter. A parameter may be any key/value pair and a user may include as many netvariables pairs as wanted. Furthermore, a value of a netvariable may be updated automatically from another source.

More particularly, NetVariable supports the action modes SET and CACHE. With SET, the variables are saved to disk as key/value pairs. The actions SET, GET, INCREMENT, and DECREMENT are acceptable in the SET mode. CACHE caches the key/value pairs in the memory of the web server with the last updated timestamp. The actions CACHE, GETCACHE, and PERSIST are acceptable in the CACHE mode. In both action modes, the user may access NetVariable by the NetID and the key. The NetVariable has the format http://myserver.domain.com/NetVariable?NETID=user_net_id&ACTION=action_c ode&parameter=value&key1=value1&key2=value2 . . . &key_n=value_n.

Six classes are defined in NetVariable. NetConstant has the list of reserved words used in user requests, for example, but not limited to, Get, Set, Increment and Decrement. NetHelper is a helper class containing methods for read/write NetVariables. CacheVariable has the data structure for a single in-memory cached NetVariable containing name, value and timestamp. CacheVariableList is a data structure implemented using LinkedList for caching CacheVariables. Elements are sorted by timestamp in the CacheVariable objects.

Also, NetVariable is the main servlet class to handle user requests. Init initializes the servlet and reads the properties file, either cached or set. Destroy destroys the servlet after persisting the cache variables which have the persist flag set to true. DoGet posts, for example, a request or a response. DoPost creates the object action of the class ActionUtil. Also, for all key value pairs, DoPost performs the correct action based on the parameters. In addition, in DoPost, details of the actions are given in the class ActionHandler.

The ActionHandler is an inner class inside NetVariable that processes user requests. ACTION will get/set, increment/decrement, encrypt/decrypt or lock/unlock variables. AFTERTIME with get the newly cached variables after the given timestamp. LASTX functions to give the last X messages. NETID gets and/or specifies the ID or usercode of a NetVariable. Data will be saved/retrieved to/from the shared file if NETID is not specified. NETPASSWORD gets the password of a NetVariable and specifies the NetPassword, if provided. ADD PARAMETER adds the parameter's key/value pair.

Using GET retrieves all the netvariables associated with the NETID. If no NetID is given, shared netvariables will be retrieved. SET will set a net variable and the updated value will be saved to the file associated with the NETID. If no NetID is given, shared netvariables will be updated Using INCREMENT will increment the variable specified by the parameters, i.e., key=incrementBy. For example, if “key1=2&action=INCREMENT” is submitted with the request and key1's value is 3 on the server, the updated value key1=5 will be saved. Using DECREMENT will decrement the variable specified by the parameters, i.e., key=decrementBy. For example, if “key1=2&action=DECREMENT” is submitted with the request and key1's value is 3 on the server, the updated value key1=1 will be saved.

In the following non-limiting examples exemplifying the use of NetVariables and parameter values the standard Internet http protocol and IP address are omitted. It would be well-known to one of ordinary skill in the art to include the http and IP address protocols with proper path indicators and to name netvariable files as desired.

To update or set someone's netvariables, /NetVariable?test=my+first+test+string&first=1 &second=2&NETID=someone&action=set may be used. To update the shared cache, which is not saved to the file, e.g., for chat, /NetVariable?action=cache&chat=hello may be used. To get all the net variables in someone's file, /NetVariable?NETID=someone&action=get may be used. To get the value of “second”, NetVariable?second=&NETID=someone&action=get may be used. To get all the net variables in the shared file, /NetVariable?action=get.

Also, to decrement a counter, /Netvariable? second=1&NETID=someone&action=decrement may be used. If the counter is not found on the server, it is set to 0. To increment a counter, /Net Variable?second=3&NETID=someone&action=increment may be used.

Reference code, including pseudo code, for NetVariables is provided. The code public class NetVariable extends HttpServlet for the NetVariable class. The code public void init( ) throws a ServletException to initialize the servlet and public void destroy ( ) destroys the servlet. The code public void doPost( ) calls an Action Class, i.e., ACTION, AFTERTIME, LASTX, NETID, and NETPASSWORD with appropriate parameters as provided herein.

For the purposes of this and other examples “Some One” or “someone” generically represents any user's, group's or person's name or other identifier and “website” generically represents a named website associated with the netvariable. Also, as previously described the standard Internet http protocol and www address is omitted from the URL.

A user may put a webpage under a variable name. In a nonlimiting example “Some One's Webpage” will map to the appropriate URL, e.g., website.com/getvariable?name=Some One's Webpage, and retrieve the content of the webpage. This precludes the user from having to enter some-one.com/webpage.htm etc.

In another nonlimiting example, a netvariable may be assigned to some piece of information, for example, someone's age. That is, SomeOne.Age=33 is a netvariable whose value can be changed or updated to 34 next year. Thus, anyone interested in SomeOne's age will refer to this variable and use it. This information is stored in the server in an html file. Access may be restricted with a passcode. For example, a netvariable defined to store the number of visitors to a website can be retrieved by anyone with authorized access for monitoring and updating purposes.

As netvariables may be saved on a server, they may be used to create shared programs accessible by many users. For example, a list of all counties in the United States may be stored by the U.S. Government in a netvariable such as USGov.ListOfCounties which gives an html list of all the county names, etc. Any user simply references the netvariable name, instead of going to a search engine, searching, pulling the list of websites, and surfing the various websites to locate the information. Other non-limiting shared programs may store maps, currency exchange rates, and stock information can be called or plugged-in easily when stored in netvariables.

The present invention also provides implementations of Netvariables, such as, but not limited to NetClipboard or a NetMemory and Collaborative ZCubes or Collaborative ZSpaces. For example, a window called the NetClipboard is utilized by users to store/retrieve/delete information. Text, URL links, images, or a combination of these or a ZCube containing the same can be dragged/dropped into a page which is defined as a NetClipboard. A unique identifier (UNID) may be created for this NetClipboard. The dragging/dropping action triggers the creation of a new variable inside the NetClipboard, which may be a collection for the specific user instance. This can then later be listed, queried, copied back to ZSpace, or deleted. The NetClipboard can function as an independent module that is used by any website to remember information clipped from websites. The information so captured is stored on a hard disk or in the memory of the Netvariables server.

Also, some ZCubes can be marked as Collaborative ZCubes or Collaborative ZSpaces. Within these, any change to the contents of the ZCube is stored into a NetVariable which is then queried using a QJax call by other clients to synchronize. ZPaint can also collaborate using the same technique by storing changes on the Paint/WhiteBoard/Blackboard, including changes to hand drawn or handwritten content, into a Netvariable that is then synchronized with other clients. This may be used to create Live Blog Mechanisms, Shared Whiteboard, ZChat, NetDiscussion Rooms, etc. over a thin recursive browser. ZCubes and ZPaint are as defined herein and are futher exemplified in U.S. Ser. No. 11/521,160 entitled System for Controlling Objects in a Recursive Browser System to Pally, filed on Sep. 14, 2006, that is incorporated herein in its entirety.

For example, if two people want to chat, a NetPage is created with a UNID in which to type the messages to each other. Each person can put in and/or view the content of the NetPage simultaneously, enabling exchange of information.

For example, if person A wants to chat with person B, their names are accepted and a NetPage is created with a UNID using a combination of their names. So if person A starts the chat, the NetPage is created immediately and when person B comes in, s/he can see the contents of the NetPage created by person A. At this point, they can exchange information between them using the same NetPage. These NetPages and messages may be stored in cache memory and those present for more than 15 minutes are deleted.

In a related implementation a NetPage may be created for a discussion topic and anyone who wants to participate in the discussion can open this NetPage and participate as described for the ‘Chat’ implementation. Discussion topics may be categorized, including subtopics, in a conventional manner. A NetDiscussion uses a conceptual channel which may contain any information, such as, but not limited to, chat, a movie, pictures, text, etc., which is viewable by all participants in the channel. In addition if two group participants wish to engage in private chat, they can create a NetPage with a UNID unique to their names, as discussed for the “Chat” implementation, separate from the group NetPage. Alternatively, it is contemplated that a private chat can be implemented within the group NetPage.

As described herein, the invention provides a number of advantages and uses. Embodiments of the present invention are better described below with reference to the Figures, however, such description or reference is not meant to limit the present invention in any fashion. The embodiments and variations described in detail herein are to be interpreted by the appended claims and equivalents thereof.

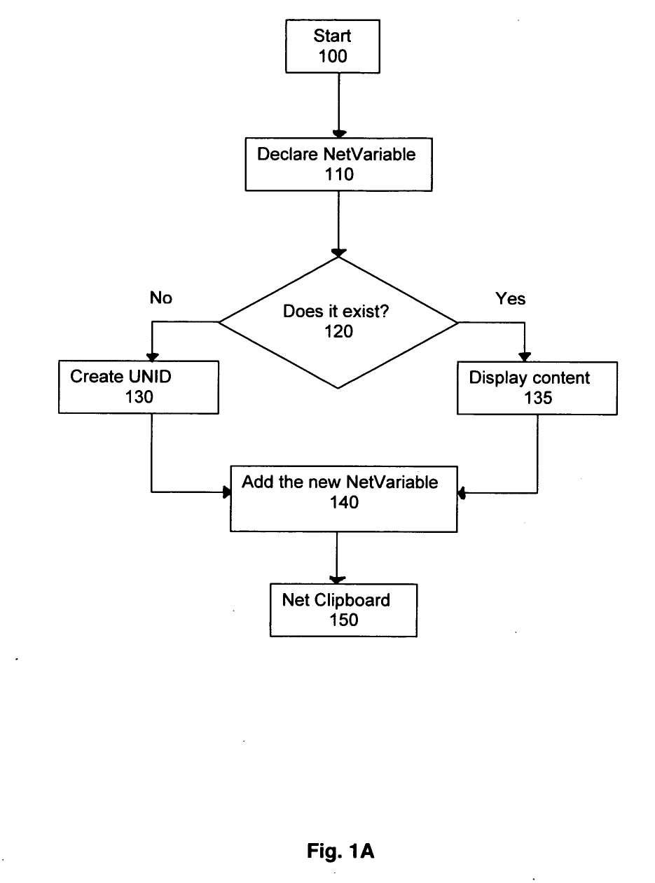

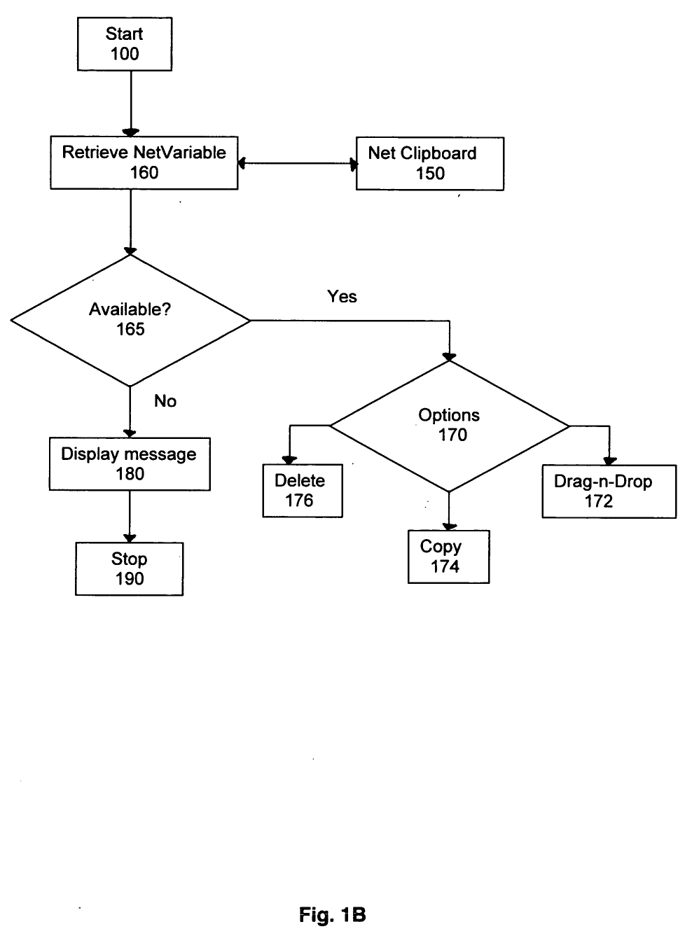

FIG. 1A is a flowchart illustrating the addition of content to a NetClipboard. Starting at 100 a netvariable is declared at step 110. A check is made to determine if the declared netvariable exists at step 120. If No, a unique identifier (UNID) is created at step 130. If yes, the content of the declared netvariable is displayed at step 135. At step 140, the content for either step 130 or 135 becomes a new netvariable and is added to the NetClipboard 150.

With continued reference to FIG. 1A, FIG. 1B is a flowchart illustrating the retrieval of content from a NetClipboard. Starting at 100, a request is made to retrieve the netvariable at step 160 from the NetClipboard 150. At step 165 it must be determined whether the netvariable is available. If No, the unavailablity is displayed as a message at step 180 and the process stops at step 190. If Yes, an option is chosen at step 170. Options, which appear as tabs in the NetClipboard, may include, although are not limited to, dragging/dropping the netvariable into the browser window at step 172, copying the content of the netvariable at step 174 or deleting the netvariable at step 176.

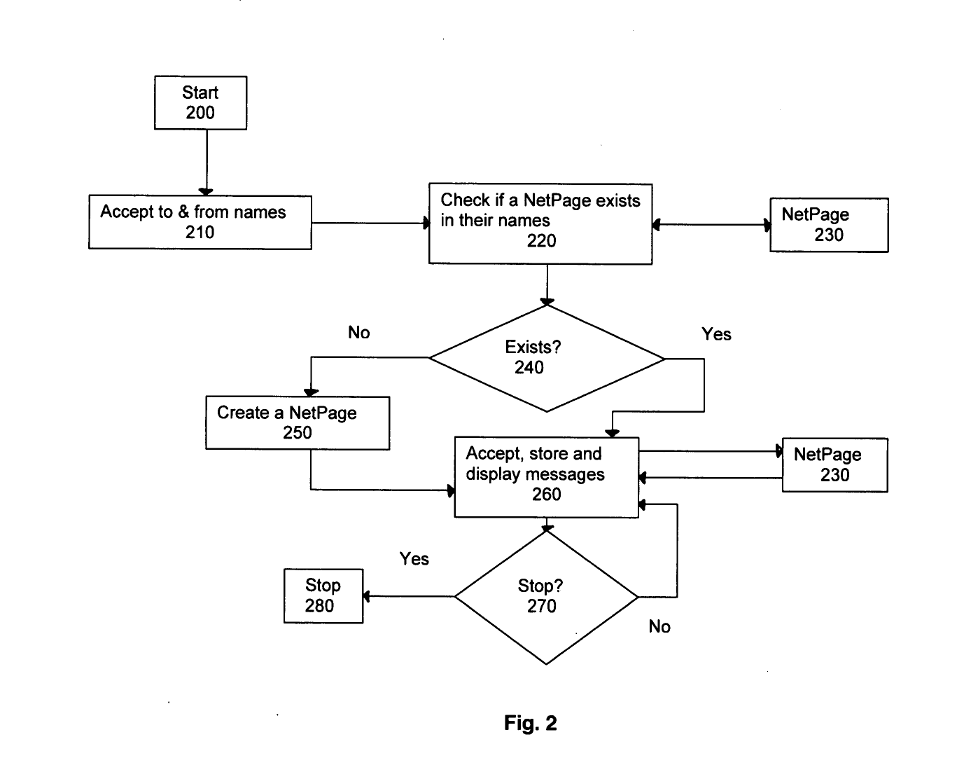

FIG. 2 is a flowchart of the steps to create and/or participate in an Internet Chat between two users via netvariables. Starting at step 200, both users participate by accepting the names each other uses at step 210. Then, at step 220 a check must be made to determine if a NetPage 230 exists for those names. If No, then step 250 creates a Net page via netvariables as discussed herein which is succeeded by step 260 whereupon messages posted on the NetPage 230 during the Chat session are accepted, stored and displayed. If Yes, the user(s) proceed directly to step 260. At step 270 a decision is made whether the Chat seesion should stop. If Yes, the Chat session ends at step 280. If No, the two users continue to participate as described in step 260.

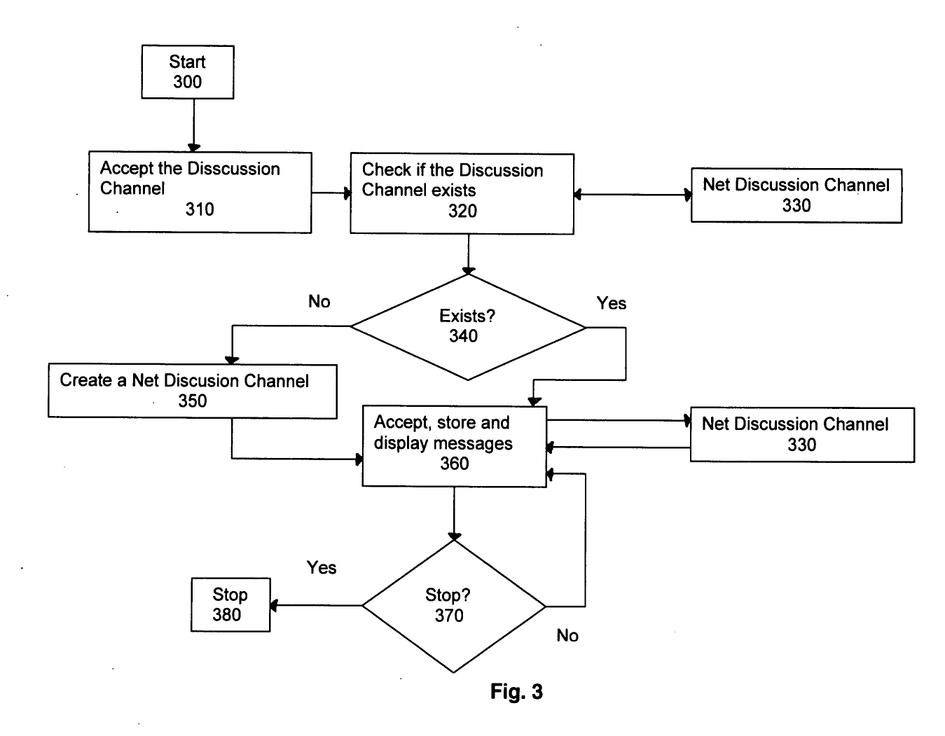

FIG. 3 is a flowchart of the steps to create and/or participate in a NetDiscussion Room via netvariables. Similarly to the process in FIG. 2 and starting at step 300 one or more users participate by accepting the discussion channel at step 310. First, a check must be made at step 320 to determine if the NetDiscussion Channel 330 exists. If No, then step 350 creates a NetDiscussion Channel 330 via netvariables as discussed herein which is succeeded by step 360 whereupon messages posted over the NetDiscussion Channel 330 in the NetDiscussion Room are accepted, stored and displayed. If Yes, the user(s) proceed directly to step 360. At step 370 a decision is made whether a user wishes to stop participating in the discussion. If Yes, the group discussion stops for that user at step 380. If No, the user continues to participate as described in step 360.

One skilled in the art will appreciate readily that the present invention is well adapted to carry out the objects and obtain the ends and advantages inherent herein. The present examples, along with the methods, procedures, systems, and/or applications described herein are presently representative of preferred embodiments, are exemplary and are not intended as limitations on the scope of the invention. Changes therein and other uses will occur to those skilled in the art which are encompassed within the spirit of the invention as defined by the scope of the claims.

What is claimed is:

1. A recursive web browser system, comprising:
a computer having a processor and a recursive web browser configured to recursively display in a browser window thereof one or more recursive webpages therein;
a network connection to one or more other computers comprising a network;
a computer memory coupled to the processor storing at least one netvariable associated with a complete Uniform Resource Locator (URL) address, including storing instructions adapted to be executed by the processor to manipulate the netvariable(s) or content therein; and
means for retrieving or storing the netvariables onto the computer or the other computer(s) over the network.

2. The recursive web browser system of claim 1, said computer memory further including executable instructions to create one or more netvariables.

3. The recursive web browser system of claim 1, further comprising means for launching one or more user-requested actions executable on the netvariable(s).

4. The recursive web browser system of claim 3, wherein the means for launching one or more user-requested actions is an action bar within a recursive browser window or an address bar located in a browser platform associated with the recursive web browser which triggers the action bar.

5. The recursive web browser system of claim 3, wherein the action is to create a net variable, to get a netvariable, to set a netvariable, to cache a netvariable, or to change a value of a netvariable.

6. The recursive web browser system of claim 5, wherein a change of a value comprises a value increment, a value decrement or an automatic update of a value from another source.

7. The recursive web browser system of claim 1, wherein the netvariable comprises an assigned name and a value pair.

8. The recursive web browser system of claim 7, wherein the netvariable further comprises a user passcode.

9. The recursive web browser system of claim 1, wherein the netvariable contains content comprising text, URL links, images, or a combination thereof or one or more ZCubes comprising the same.

10. The recursive web browser system of claim 1, wherein the netvariable is implemented as a collaborative page or window shared by two or more computers over the network.

11. The recursive web browser system of claim 10, wherein the collaborative page is assigned a unique identifier to restrict user(s) access thereto.

12. The recursive web browser system of claim 10, wherein a drag/drop action or creation of content within the page or window creates another netvariable therewithin containing the dropped or created content.

13. The recursive web browser system of claim 12, wherein a change to the content within a collaborative page or window is synchronized with other computers having access thereto.

14. The recursive web browser system of claim 10, wherein the collaboration within the page is chatting, messaging, a group discussion or other sharing of content contained within the collaborative web page.

15. The recursive web browser system of claim 14, wherein the content is stored only in cache memory.

16. The recursive web browser system of claim 10, wherein the collaboration within the window is a clipboard.

17. The recursive web browser system of claim 1, wherein the netvariables or one or more changes thereto are stored in a memory cache or on a hard disk.

18. A recursive web browser, comprising:
a recursive browser window configured to recursively display one or more recursive webpages;
means for accessing a computer memory coupled to a processor and storing at least one netvariable of claim 1 and instructions adapted to be executed by the processor to manipulate the netvariable(s) or content therein; and
means for launching one or more user-requested actions executable on the netvariable(s).

19. The recursive web browser of claim 18, further comprising:
a network connection to one or more computers comprising a network; and
means for retrieving the netvariables from or storing the netvariables onto the one or more computers.

20. The recursive web browser system of claim 18, said computer memory further storing executable instructions to create one or more netvariables.

21. The recursive web browser system of claim 18, wherein the means for launching one or more user-requested actions is an action bar within a recursive browser window or an address bar located in a browser platform associated with the recursive web browser which triggers the action bar.

22. The recursive web browser system of claim 21, wherein the action is effective to create a net variable, to get a netvariable, to set a netvariable, to cache a netvariable, or to change a value of a netvariable.

23. The recursive web browser of claim 22, wherein a change of a value comprises a value increment, a value decrement or an automatic update of a value from another source

24. A method for retrieving webpage content, comprising:
providing the recursive web browser system of claim 1;
selecting one or more netvariables each corresponding to a complete Uniform Resource Locator (URL) address from a computer memory storing the same;
mapping the selected netvariable(s) to the corresponding complete URLs; and
retrieving webpage content associated with the URL(s) and displaying the retrieved content in a recursive browser page or window.

25. The method of claim 24, further comprising:
creating one or more netvariables.

26. The method of claim 25, further comprising storing the created netvariable(s) in the computer memory.

27. The method of claim 24, further comprising:
implementing the netvariable as a collaborative page or window shared by two or more computers over the network.

28. The method of claim 27, further comprising:
assigning a unique identifier to the collaborative page to restrict user(s) access thereto.

29. The method of claim 27, further comprising:
changing content within the collaborative page or window thereby creating another netvariable containing the same therewithin.

30. The method of claim 29, further comprising:
synchronizing the change to the content with other computers having access thereto.

31. The method of claim 24, further comprising:
applying an action parameter to the netvariable.

32. The method of claim 31, wherein the action parameter is effective to create a net variable, to get a netvariable, to set a netvariable, to cache a netvariable, or to change a value of a netvariable.

33. The method of claim 32, wherein a change in value comprises incrementing a value, decrementing a value, or updating automatically a value from another source.

34. The method of claim 24, wherein the computer memory comprises one or more computers networked within the recursive browser system.

35. A computer program product having a memory, a plurality of netvariables being stored in the memory, the memory further storing a method of retrieving webpage content comprising the steps of:
mapping a selected netvariable to a corresponding complete URL; and
retrieving web page content associated with the URL(s) and displaying the retrieved content in a recursive browser page or window.

36. The computer program product of claim 35, said stored method further comprising:
creating one or more netvariables.

37. The computer program product of claim 35, said stored method further comprising:
implementing a netvariable as a collaborative page or window shared by two or more computers over a network.

38. The computer program product of claim 37, said stored method further comprising:
assigning a unique identifier to the collaborative page to restrict user(s) access thereto.

39. The computer program product of claim 37, said stored method further comprising:
changing content within the collaborative page or window thereby creating another netvariable containing the same therewithin.

40. The computer program product of claim 39, said stored method further comprising:
synchronizing the change to the content with other computers having access thereto over a network.

41. The computer program product of claim 37, wherein the collaboration within the page is chatting, messaging, a group discussion or other sharing of content contained within the collaborative web page.

42. The computer program product of claim 37, wherein the collaboration within the window is a clipboard.

43. The computer program product of claim 35, said stored method further comprising:
applying an action parameter to the netvariable.

44. The computer program product of claim 43, wherein the action parameter is effective to create a net variable, to get a netvariable, to set a netvariable, to cache a netvariable, or to change a value of a netvariable.

45. The computer program product of claim 44, wherein a change of a value comprises a value increment, a value decrement or an automatic update of a value from another source.

46. The computer program product of claim 35, wherein the netvariable comprises a name and a value pair.

47. The computer program product of claim 46, wherein the netvariable further comprises a user passcode.

48. The computer program product of claim 35, wherein content within the netvariable is text, URL links, images, or a combination thereof or one or more ZCubes comprising the same.
